(19) United States
(12) Patent Application Publication
(10) Pub. No.: US 2026/0297325 A1
(43) Pub. Date: Oct. 1, 2026

(54) PROCESSES FOR PREPARING A MIXTURE THAT CONTAINS A POLYOXYALKYLENE POLYOL

(71) Applicant: Covestro Deutschland AG, Leverkusen (DE)

(72) Inventors: Klaus Lorenz, Dormagen (DE); Ingo Danek, Köln (DE)

(21) Appl. No.: 19/477,585

(22) PCT Filed: May 7, 2024
(86) PCT No.: PCT/EP2024/062516

§ 371 Date: Oct. 22, 2025

(30) Foreign Application Priority Data
May 11, 2023 (EP) 23172723.1

(51) Int. Cl. C08L 71/02; C08G 65/26

(52) U.S. Cl. CPC C08L 71/02; C08G 65/2609; C08L 2205/025

(57) ABSTRACT

The invention relates to processes for preparing a mixture that contains a polyoxyalkylene polyol, preferably a polyether polyol, to the mixtures obtainable by the process and to a mixture that contains a polyoxyalkylene polyol, preferably a polyether polyol and an alkoxylated oxoacid of phosphorus.

The present invention provides a process for producing a mixture comprising a polyoxyalkylene polyol, preferably a polyether polyol, the mixture obtained by the process and a mixture comprising a polyoxyalkylene polyol, preferably a polyether polyol, and an alkoxylated oxygen acid of phosphorus.

Polyoxyalkylene polyols suitable for the preparation of polyurethanes can be obtained via various preparation processes. Methods of industrial significance are firstly the base-catalyzed addition of alkylene oxides onto H-functional starter compounds, and secondly the use of double metal cyanide compounds as catalysts (“DMC catalysts”) for the addition of alkylene oxides onto H-functional starter compounds. However, the production of short-chain polyoxyalkylene polyols with hydroxyl numbers (OH numbers) greater than about 300 mg KOH/g is barely achievable with DMC catalysts, since they have only low activities in the presence of high concentrations of hydroxyl groups or cannot be activated in the presence of high concentrations of hydroxyl groups. The (Lewis) acid-catalyzed addition of alkylene oxides onto suitable starter compounds is of minor importance because of the tendency to formation of unwanted low molecular weight by-products, especially in the case of preparation of long-chain polyoxyalkylene polyols. Amines may in principle be used as catalysts for the addition of alkylene oxides onto starter compounds; particularly suitable amines here have been found to be heterocyclic amines, for example imidazole and its derivatives. With these catalysts, OH numbers of at least about 200 mg KOH/g are obtainable (equivalent molar mass about 280 g/mol). A disadvantage in the case of use of amine catalysts has in many cases been found to be that their residues remaining in the end product impart frequently undesirable reactivity to polyurethane systems. For the preparation of short-chain polyoxyalkylene polyols with high OH numbers of 400 mg KOH/g or higher, acid catalysis is in principle an alternative of industrial interest to base catalysis, since there is not yet much of a tendency to formation of low molecular weight by-products in this hydroxyl number range. It appears to the authors that the use of oxygen acids of phosphorus as catalysts, and here in particular that of phosphoric acid itself, is particularly attractive for industrial purposes in this context since they are converted to their esters by alkoxylation and hence high-quality short-chain polyoxyalkylene polyols that are free of catalyst residues or contain only small catalyst traces can be obtained without further workup steps. However, it is probably because of the actually beneficial fact that the catalytic activity of the oxo acids of phosphorus is lost during the alkylation that it is found to be exceedingly difficult to obtain polyols with OH numbers of less than 450 mg KOH/g under exclusive catalysis by a phosphorus oxo acid, especially when the final products are not supposed to contain excessively high levels of phosphorus oxo esters. It was therefore an object of the present invention to provide an easy-to-perform process by which polyoxyalkylene polyols in the OH number range from 250 mg KOH/g to 600 mg KOH/g can be obtained, which do not contain any alkali or alkaline earth metal residues nor any other catalyst residues that may affect subsequent foaming reactions, for example any great concentrations of free amines. The process should additionally feature smooth absorption of the alkylene oxide.

The state of the art in the field of (Lewis) acid-catalyzed processes, or of processes that combine DMC catalysis and acid catalysis, is as follows:

EP 1125961 A1 discloses hydrophobic polyethers with more than 40% primary OH groups that are preparable exclusively on the basis of propylene oxide, i.e. without the use of ethylene oxide. The high content of primary OH groups is achieved by using Lewis acid catalysts based on boron and Al with phenyl radicals. In particular, B(C₆F₅)₃ and Al(C₆F₅)₃ are recommended. The examples only need very small amounts of catalyst if it is added continuously to the starter with the alkylene oxide.

Only long-chain polyols having maximum OH numbers of 56 mg KOH/g are prepared in the examples. Ready-made alkylene oxide adducts are used as starters for preparation thereof. The disadvantage of this disclosed method is found to be the high moisture sensitivity of the tris(pentafluoro)phenylborane or aluminum. In the examples of EP 2415798 A1 too, only the Lewis-acidic catalyst tris(pentafluoro)phenylborane is used, but here with the aim of obtaining long-chain polyethers with a relatively low content of unsaturated end groups with simultaneous use of only small amounts of ethylene oxide.

Patent application WO 2016/064698 A1 discloses a 2-stage process for preparing polyether polyols having a high content of primary OH groups, characterized in that, in a 1st stage (proceeding from a starter with molar mass <1000 Da), an intermediate product is obtained under DMC catalysis, a Lewis acid (preferably tris(pentafluorophenyl) borane) is added to this intermediate product, and epoxide is then added at a temperature lower than in the DMC-catalyzed step. The necessary deactivation of the DMC catalyst thus apparently takes place through lowering of the temperature.

Disadvantages of this method are that it is unsuitable for the preparation of short-chain polyols (only polyethers with molar masses greater than 2500 Da are prepared), and again the use of the moisture-sensitive catalyst tris(pentafluorophenyl) borane.

The two patent applications WO 2017194709 A1 and WO 2012084762 A1 disclose 2-stage processes each comprising a base-catalyzed and a DMC-catalyzed step for obtaining polyether polyols with OH numbers >200 mg KOH/g or those with OH numbers between 3 and 150 mg KOH/g. These processes are used robust catalysts, and they do not require removal of catalyst residues; the process claimed in WO 2017/194709 is additionally suitable for the preparation of typical short-chain rigid-foam polyoxyalkylene polyols. However, a disadvantage is found to be that the resultant polyoxyalkylene polyols are not entirely free of alkali metal salts.

Application WO 2012/134849 A1 discloses a reaction sequence consisting of a superacid-catalyzed reaction step followed by a DMC step, with the aim of obtaining, in a workup-free manner, short-chain polyoxyalkylene polyols with a low content of primary OH groups that are suitable for rigid foam applications. The superacid is not separated off before the DMC step, but can optionally be neutralized. A problem with the process claimed is the use of the highly aggressive superacid CF₃SO₃H; moreover, it has surprisingly been found in the course of the studies that led to the present invention that the neutralization method employed in WO 2012/134849 A1 affects the activity of the DMC catalyst in a disadvantageous manner.

Patent application WO 2005/118678 A1 describes a two-stage process for preparing phosphorus-containing polyethers via DMC catalysis: the phosphorus compounds, which are generally oxygen acids of phosphorus and partly esterified derivatives thereof, are admixed with 0.5-3 mol of alkylene oxide/OH group in a first, uncatalyzed step. After the epoxide has been depleted in this first stage, the DMC catalyst is added and reacted with epoxide by different processes until attainment of the target molecular weight. It is emphasized that it is a feature of the process that no aftertreatment of the precursor is required, and the precursor can instead be subjected directly to the DMC-catalyzed alkoxylation step. The target molar masses of the process are in the region of long-chain polyoxyalkylene polyols. The advantage of neutralization of the residual acid number remaining in the intermediate product after the first step, which is particularly apparent in the preparation of short-chain polyoxyalkylene polyols using small amounts of DMC catalyst, was not recognized.

EP 2543689 claims a continuous process for the production of polyethers which is characterized in that, in the first step of the reaction cascade, a (Lewis) acid-catalyzed step is conducted at a temperature below the typical activation temperature for DMC catalysts. In this step, an intermediate oligomeric polyol is obtained. The DMC catalytic converter may already be present in this first step.

In the 2nd step of the reaction cascade, the temperature is raised to values typical of DMC-catalyzed alkylene oxide addition processes, and the finished polyol is obtained. The target molar masses of this process are likewise in the region of long-chain polyoxyalkylene polyols. The process-related benefit of neutralization of the residual acid number remaining after stage 1 was likewise not recognized by the authors.

There is therefore no process available from the prior art that provides a route to short-chain polyoxyalkylene polyols in the OH number range from 300 to 600 mg KOH/g using active catalysts or amounts of catalyst where catalyst residues do not have to be separated off, no moisture-sensitive Lewis acids or aggressive superacids are used, and where neither alkali metal nor alkaline earth metal residues nor any great amounts of aminic catalyst residues remain in the polyoxyalkylene polyol.

It was therefore an object of the present invention to eliminate the shortcomings of the processes described in the prior art.

This object was surprisingly achieved by a process for producing a mixture comprising a polyoxyalkylene polyol, preferably a polyether polyol, comprising the following steps:
i. providing a component A) comprising a polyoxyalkylene polyol A1) having a calculated hydroxyl number (OHN_{A1}) of 600 to 1060 mg KOH/g by
   a) reacting an H-functional starter compound (B) with an alkylene oxide (C) using a component (D), where component (D) contains a Brønsted acid, to form an intermediate (E);
   b) adding an amine (F) to the intermediate (E) obtained in i-a), to form component (A);
ii. subsequently reacting component (A) with an alkylene oxide (G) in the presence of a DMC catalyst (H) to give the mixture comprising the polyoxyalkylene polyol;
   wherein the reaction in step i.-a) is effected in the absence of a superacid, and wherein the calculated amount of Brønsted acid to be added in step i.-a) is 0.5% by weight-5.0% by weight, preferably from 1.0% by weight to 4.5% by weight and more preferably from 1.5% by weight to 4.0% by weight, based on the total mass of the intermediate (E).

The process of the invention also features smooth absorption of the alkylene oxide in the alkoxylation stages i. and ii. In particular, the DMC catalyst used in stage ii. shows good activity even at low concentrations of not more than 150 ppm, based on the overall reaction mixture, which is manifested by only a small rise in pressure during the alkylene oxide addition phase. It was additionally found that a change of the reactor between the two alkoxylation stages likewise has an advantageous effect on the uptake of the epoxide in stage ii., which proceeds under DMC catalysis.

The process of the invention is elucidated in detail hereinafter, where embodiments of the invention can be combined with each other in any manner and number unless the opposite is apparent from the technical content or is obvious to the person skilled in the art.

According to the invention, the mixture comprises the polyoxyalkylene polyol, preferably the polyether polyol.

In the process of the invention, polyoxyalkylene polyols mean addition products of one or more alkylene oxides and optionally one or more comonomers, for example CO₂ and/or cyclic anhydrides, onto one or more H-functional starter compounds in the presence of a catalyst, for example the double metal cyanide (DMC) catalyst (H), where polyether polyols, polyetherester polyols, polycarbonate polyols, polyethercarbonate polyols or polyetherestercarbonate polyols are obtainable.

In a preferred embodiment of the process of the invention, the polyoxyalkylene polyol is a polyether polyol, wherein the polyether polyol is obtainable by addition of one or more alkylene oxides onto one or more H-functional starter compounds in the presence of a catalyst, for example the double metal cyanide (DMC) catalyst (H).

In line with the customary definition in the art, Brønsted acids mean substances capable of transferring protons to a second co-reactant, called the Brønsted base, typically in an aqueous medium at 25° C.

In one embodiment of the process of the invention or of the invention, the polyoxyalkylene polyol present in the mixture has an equivalent mass of 93 to 225 g/mol preferably of 93 to 190 g/mol.

The equivalent molar mass of materials containing active hydrogen atoms (H-functional starter compounds) means the total mass of the material containing active hydrogen atoms divided by the number of active hydrogen atoms. In the case of materials containing hydroxyl groups (for example polyoxyalkylene polyols), they are in the following relationship with the OH number (hydroxyl number):

$$equivalent molar mass = ( 56100 [ mg / mol ] ) / ( OHN [ mg KOH / g ] ) \qquad ( I )$$

The equivalent molar mass of the polyoxyalkylene polyol is thus ascertained by formula (I), where the OHN of the polyoxyalkylene polyol can be ascertained according to DIN 53240 or determined spectroscopically by NIR. The OHN of the polyoxyalkylene polyol is preferably determined in accordance with DIN 53240-2 (2007).

The calculated OH number of the polyoxyalkylene polyol A1) (OHN_{A1}) determined by formula (II):

$$equivalent molar mass = ( 56100 [ mg / mol ] ) / ( {OHN}_{A 1} [ mg KOH / g ] ) \qquad ( II )$$

OHN_{A1}=((mass of the H-functional starter compound (B) used in step i-a))×(OHN of the H-functional starter compound (B) used in step i-a))/(mass of the H-functional starter compound (B) used in step i-a)+mass of the alkylene oxide C used in step i-a)).

In one embodiment of the process of the invention or of the invention, the polyether polyol present in the mixture has an equivalent mass of 93 to 225 g/mol, preferably from 93 to 190 g/mol.

Starters used in step i-a) are H-functional starter compounds (B). Such starters are compounds containing at least one Zerewitinoff-active hydrogen atom, sometimes also referred to merely as “active hydrogen”. A hydrogen bonded to N, O or S is referred to as Zerewitinoff-active hydrogen when it affords methane by reaction with methylmagnesium iodide, by a method discovered by Zerewitinoff. Typical examples of compounds having Zerewitinoff-active hydrogen are compounds containing carboxyl, hydroxyl, amino, imino or thiol groups as functional groups. In the present invention, the hydrogen atoms of the hydroxyl groups of the oxygen acids of phosphorus should also be regarded as Zerewitinoff-active hydrogen atoms. Suitable H-functional starter compounds usually have functionalities of 1 to 35, preferably of 1 to 8. Their equivalent molar masses are typically below 70 g/mol. As well as the hydroxy-functional starters for use with preference, it is also possible to use amino-functional starters. Examples of hydroxy-functional starter compounds are methanol, ethanol, 1-propanol, 2-propanol, the isomers of butanol, propylene glycol, ethylene glycol, diethylene glycol, dipropylene glycol, butane-1,2-diol, butane-1,3-diol, butane-1,4-diol, hexanediol, pentanediol, 3-methylpentane-1,5-diol, glycerol, trimethylolpropane, pentaerythritol, sorbitol, sucrose, hydroquinone, catechol, resorcinol, 1,3,5-trihydroxybenzene, and methylol-containing condensates of formaldehyde and phenol or urea. It is also possible to use high-functionality starter compounds based on hydrogenated starch hydrolysis products. These are described, for example, in EP-A 1525244. Examples of H-functional starter compounds containing amino groups are ammonia, ethanolamine, diethanolamine, triethanolamine, isopropanolamine, diisopropanolamine, ethylenediamine, hexamethylenediamine, aniline, the isomers of toluidine, the isomers of diaminotoluene, the isomers of diaminodiphenylmethane, and higher polycyclic products obtained in the condensation of aniline with formaldehyde to give diaminodiphenylmethane, and also condensates of formaldehyde and melamine that contain methylol groups and Mannich bases. Starter compounds used may also be ring-opening products of cyclic carboxylic anhydrides and polyols which form very rapidly in situ after the two components have been combined. Examples are ring-opening products of phthalic anhydride, succinic anhydride and maleic anhydride on the one hand, and ethylene glycol, diethylene glycol, butane-1,2-diol, butane-1,3-diol, butane-1,4-diol, glycerol, trimethylolpropane, pentaerythritol or sorbitol on the other hand. In addition, it is also possible to use mono- or polyfunctional carboxylic acids directly as starter compounds.

In addition, step i-a) may be performed using, as well as the H-functional starter compounds (B) mentioned, also ready-made alkylene oxide addition products of these starter compounds, i.e. polyoxyalkylene polyols, preferably with OH numbers of >600 to 1100 mg KOH/g, preferably 700 to 1000 mg KOH/g. It is also possible, in the process of the invention, to use polyester polyols preferably having OH numbers in the range from >600 to, for example, 800 mg KOH/g as (co-)starters with the aim of preparing polyetheresters. Polyester polyols suitable for this purpose may be prepared, for example, from organic dicarboxylic acids and polyhydric alcohols, preferably diols, by known processes.

In addition, H-functional starter compounds (B) used as (co-)starters may be polycarbonate polyols, polyestercarbonate polyols or polyethercarbonate polyols, preferably polycarbonate diols, polyestercarbonate diols or polyethercarbonate diols, preferably each having OH numbers in the range from >600 to 800 mg KOH/g. These are prepared, for example, by reaction of phosgene, dimethyl carbonate, diethyl carbonate or diphenyl carbonate with difunctional or higher-functionality alcohols or polyester polyols or polyether polyols.

The OHN_{A1} is calculated by formula (II) using the number of —SH groups in the case of starter compounds containing thiol groups, the number of ═NH groups in the case of starter compounds containing imino groups, the number of —COOH groups in the case of starter compounds containing carboxyl groups, and the number of hydrogen atoms bonded to amine nitrogen atoms in the case of starter compounds containing amine groups.

In the process of the invention, preferably, H-functional starter compounds free of amino groups and having hydroxyl groups serve as carriers for the active hydrogens, for example methanol, ethanol, 1-propanol, 2-propanol, the isomers of butanol, propylene glycol, ethylene glycol, diethylene glycol, dipropylene glycol, butane-1,2-diol, butane-1,3-diol, butane-1,4-diol, hexanediol, pentanediol, 3-methylpentane-1,5-diol, glycerol, trimethylolpropane, pentaerythritol, sorbitol, sucrose, hydroquinone, catechol, resorcinol, 1,3,5-trihydroxybenzene, methylol-containing condensates of formaldehyde and phenol and hydrogenated starch hydrolysis products. It is also possible to use mixtures of various H-functional starter compounds.

In one embodiment of the process of the invention, the alkylene oxide (C) is one or more compounds and is selected from the group consisting of 1,2-epoxybutane, propylene oxide and ethylene oxide, preferably propylene oxide and ethylene oxide. If mixtures of ethylene oxide and propylene oxide are used in step i.-a), these preferably contain up to 50% by mass of ethylene oxide and more preferably up to 30% by mass of ethylene oxide, based on the total mass of the mixture of ethylene oxide and propylene oxide. Very particular preference is given to using exclusively propylene oxide.

The alkylene oxides (C) can be fed into the reactor as individual components or as a mixture. It is likewise possible to feed two or more alkylene oxides (C) into the reactor in succession, which makes it possible to achieve polyoxyalkylene chains having a block structure. In the metered addition of two or more alkylene oxides, it is possible to change the composition of the alkylene oxide stream supplied continuously or instantaneously.

In one embodiment of the process of the invention, component (D) consists of the Brønsted acid.

In one embodiment of the process of the invention, the Brønsted acid is an inorganic mineral acid.

In the process of the invention, the reaction is effected in the absence of a superacid, for example trifluoromethanesulfonic acid (CF₃SO₃H). In accordance with the general technical definition, superacids have a pKa of lower than minus three point zero (−3.0).

In one embodiment of the process of the invention, the Brønsted acid is sulfuric acid and/or an oxygen acid of phosphorus, preferably an oxygen acid of phosphorus. Examples of oxygen acids of phosphorus include orthophosphoric acid (phosphoric acid), phosphonic acid or phosphinic acid. In addition, it is also possible to use condensed phosphoric oxo acids, such as diphosphoric acid or diphosphonic acid, and also cyclic metaphosphoric acids. An overview of suitable phosphorus oxo acids is given, for example, in Holleman-Wiberg, Inorganic Chemistry, 91st-100th improved and significantly extended edition, Walter de Gruyter, Berlin, New York 1985, 646-664.

In one embodiment of the process of the invention, the oxygen acid or phosphorus has a structure of formula (III):

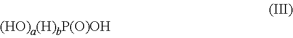

with a=0, 1 or 2 and b=0, 1 or 2, where a+b=2.

In a preferred embodiment of the process of the invention, the oxygen acid of phosphorus is phosphinic acid (with a=0, b=2), phosphonic acid (with a=1, b=1) and/or phosphoric acid (orthophosphoric acid, with a=2, b=0), more preferably phosphoric acid (orthophosphoric acid). According to the invention, the calculated amount of Brønsted acid to be added in step i.-a) is 0.5% by weight-5.0% by weight, preferably from 1.0% by weight to 4.5% by weight and more preferably from 1.5% by weight to 4.0% by weight, based on the total mass of the intermediate (E).

In one embodiment of the process of the invention, the amount of the amine (F) added in step i.-b) is such that ≥0.5 to ≤2.2, preferably ≥0.8 to ≤2.0, amine nitrogen equivalents are added per residual acid equivalent in intermediate (E) in step i.-b). The residual acid equivalent is determined here with the aid of the ASTM D 7253 (2016) method.

In one embodiment of the process of the invention, the amine (F) is a tertiary amine, preferably a tertiary amine containing hydroxyl groups.

In one embodiment of the process of the invention the tertiary amine, preferably the tertiary amine containing hydroxyl groups, has a hydroxyl number of 300 mg KOH/g to 1200 mg, preferably of 350 mg KOH/g to 1000 mg KOH/g, more preferably of 400 mg KOH/g to 800 mg, where the hydroxyl number has been determined by the DIN 53240-2 (2007) method.

In one embodiment of the process of the invention, the tertiary amine is a tertiary amine containing hydroxyl groups, and the tertiary amine containing hydroxyl groups is obtainable, preferably obtained, by reaction of ammonia, a primary amine, for example methylamine, ethylamine, propylamine, isopropylamine, butylamine, sec-butylamine, N,N-dimethylaminopropylamine, a primary diamine, for example ethylenediamine, 1,3-diaminopropane, hexamethylenediamine, tolylenediamine, a secondary amine, for example dimethylamine, dibutylamine, diisopropylamine, diethanolamine, N-methylethanolamine, and/or a secondary diamine, for example N,N′-dimethylaminopropylamine, with an alkylene oxide (I).

In a further embodiment of the process of the invention, the tertiary amine containing hydroxyl groups is also obtainable, and preferably is indeed obtained, by chain extension of tertiary alcoholamines such as triisopropanolamine and/or triethanolamine with alkylene oxide (I) such as propylene oxide and/or ethylene oxide.

In one embodiment of the process of the invention, the alkylene oxide (G) is one or more compounds and is selected from the group consisting of 1,2-epoxybutane, propylene oxide and ethylene oxide. If mixtures of ethylene oxide and propylene oxide are used in step ii.), these preferably contain up to 50% by mass of ethylene oxide and more preferably up to 30% by mass of ethylene oxide, based on the total mass of the mixture of ethylene oxide and propylene oxide. Very particular preference is given to using exclusively propylene oxide. The alkylene oxides (G) can be fed into the reactor as individual components or as a mixture. It is likewise possible to feed two or more alkylene oxides (G) into the reactor in succession, which makes it possible to achieve polyoxyalkylene chains having a block structure. In the metered addition of two or more alkylene oxides, it is possible to change the composition of the alkylene oxide stream supplied continuously or instantaneously.

Further monomers copolymerizable with alkylene oxides (G) under DMC catalysis in step ii) by the process of the invention are, for example, aliphatic lactones, aromatic lactones, lactides, cyclic carbonates having preferably at least three optionally substituted methylene groups between the oxygen atoms of the carbonate group, aliphatic cyclic anhydrides, aromatic cyclic anhydrides and carbon dioxide.

Aliphatic or aromatic lactones are cyclic compounds containing an ester bond in the ring. Preferred compounds are 4-membered-ring lactones such as β-propiolactone, β-butyrolactone, β-isovalerolactone, β-caprolactone, β-isocaprolactone, β-methyl-β-valerolactone, 5-membered-ring γ-butyrolactone, γ-valerolactone, 5-methylfuran-2 (3H)-one, 5-lactones, such as methylidenedihydrofuran-2 (3H)-one, 5-hydroxyfuran-2 (5H)-one, 2-benzofuran-1 (3H)-one and 6-methyl-2-benzofuran-1 (3H)-one, 6-membered-ring lactones, such as δ-valerolactone, 1,4-dioxan-2-one, dihydrocoumarin, 1H-isochromen-1-one, 8H-pyrano[3,4-b]pyridin-8-one, 1,4-dihydro-3H-isochromen-3-one, 7,8-dihydro-5H-pyrano[4,3-b]pyridin-5-one, 4-methyl-3,4-dihydro-1H-pyrano[3,4-b]pyridin-1-one, 6-hydroxy-3,4-dihydro-1H-isochromen-1-one, 7-hydroxy-3,4-dihydro-2H-chromen-2-one, 3-ethyl-1H-isochromen-1-one, 3-(hydroxymethyl)-1H-isochromen-1-one, 9-hydroxy-1H,3H-benzo[de]isochromen-1-one, 6,7-dimethoxy-1,4-dihydro-3H-isochromen-3-one and 3-phenyl-3,4-dihydro-1H-isochromen-1-one, 7-membered-ring lactones, such as ε-caprolactone, 1,5-dioxepan-2-one, 5-methyloxepan-2-one, oxepane-2,7-dione, thiepan-2-one, 5-chlorooxepan-2-one, (4S)-4-(propan-2-yl)oxepan-2-one, 7-butyloxepan-2-one, 5-(4-aminobutyl)oxepan-2-one, 5-phenyloxepan-2-one, 7-hexyloxepan-2-one, (5S,7S)-5-methyl-7-(propan-2-yl)oxepan-2-one, 4-methyl-7-(propan-2-yl)oxepan-2-one, and lactones with higher numbers of ring members, such as (7E)-oxacycloheptadec-7-en-2-one.

Lactides are cyclic compounds containing two or more ester bonds in the ring. Preferred compounds are glycolide (1,4-dioxane-2,5-dione), L-lactide (L-3,6-dimethyl-1,4-dioxane-2,5-dione), D-lactide, DL-lactide, mesolactide and 3-methyl-1,4-dioxane-2,5-dione, 3-hexyl-6-methyl-1,4-dioxane-2,5-dione, and 3,6-di(but-3-en-1-yl)-1,4-dioxane-2,5-dione (in each case inclusive of optically active forms). L-lactide is particularly preferred.

Cyclic carbonates used are preferably compounds having at least three optionally substituted methylene groups between the oxygen atoms of the carbonate group. Preferred compounds are trimethylene carbonate, neopentyl glycol carbonate (5,5-dimethyl-1,3-dioxan-2-one), 2,2,4-trimethylpentane-1,3-diol carbonate, 2,2-dimethylbutane-1,3-diol carbonate, butane-1,3-diol carbonate, 2-methylpropane-1,3-diol carbonate, pentane-2,4-diol carbonate, 2-methylbutane-1,3-diol carbonate, TMP monoallyl ether carbonate, pentaerythritol diallyl ether carbonate, 5-(2-hydroxyethyl)-1,3-dioxan-2-one, 5-[2-(benzyloxy)ethyl]-1,3-dioxan-2-one, 4-ethyl-1,3-dioxolan-2-one, 1,3-dioxolan-2-one, 5-ethyl-5-methyl-1,3-dioxan-2-one, 5,5-diethyl-1,3-dioxan-2-one, 5-methyl-5-propyl-1,3-dioxan-2-one, 5-(phenylamino)-1,3-dioxan-2-one and 5,5-dipropyl-1,3-dioxan-2-one. Particular preference is given to trimethylene carbonate and neopentyl glycol carbonate.

Under the conditions of the process of the invention, cyclic carbonates having fewer than three optionally substituted methylene groups between the oxygen atoms of the carbonate group are incorporated into the polymer chain not at all or only to a small extent.

Cyclic anhydrides are cyclic compounds containing an anhydride group in the ring. Preferred compounds are succinic anhydride, maleic anhydride, phthalic anhydride, cyclohexane-1,2-dicarboxylic anhydride, diphenic anhydride, tetrahydrophthalic anhydride, methyltetrahydrophthalic anhydride, norbornenedioic anhydride and chlorination products thereof, succinic anhydride, glutaric anhydride, diglycolic anhydride, 1,8-naphthalic anhydride, succinic anhydride, dodecenylsuccinic anhydride, tetradecenylsuccinic anhydride, hexadecenylsuccinic anhydride, octadecenylsuccinic anhydride, 3- and 4-nitrophthalic anhydride, tetrachlorophthalic anhydride, tetrabromophthalic anhydride, itaconic anhydride, dimethylmaleic anhydride, allylnorbornenedioic anhydride, 3-methylfuran-2,5-dione, 3-methyldihydrofuran-2,5-dione, dihydro-2H-pyran-2,6 (3H)-dione, 1,4-dioxane-2,6-dione, 2H-pyran-2,4,6 (3H,5H)-trione, 3-ethyldihydrofuran-2,5-dione, 3-methoxydihydrofuran-2,5-dione, 3-(prop-2-en-1-yl)dihydrofuran-2,5-dione, N-(2,5-dioxotetrahydrofuran-3-yl) formamide and 3 [(2E)-but-2-en-1-yl]dihydrofuran-2,5-dione. Particular preference is given to succinic anhydride, maleic anhydride and phthalic anhydride.

The use thereof is also described in U.S. Pat. Nos. 3,538,043, 4,500,704, 5,032,671, 6,646,100, EP-A 222453 and WO-A 2008/013731.

In one embodiment of the process of the invention, the DMC catalyst (H) is used in amounts of 30 to 150 ppm, based on the amount of component (A) and alkylene oxide (G).

DMC catalysts (H) suitable for the process of the invention are known in principle from the prior art (see, for example, U.S. Pat. Nos. 3,404,109, 3,829,505, 3,941,849 and 5,158,922). DMC catalysts, which are described, for example, in U.S. Pat. No. 5,470,813, EP-A 700949, EP-A 743093, EP-A 761708, WO 97/40086, WO 98/16310 and WO 00/47649, have a very high activity in the polymerization of alkylene oxides and enable the preparation of polyoxyalkylene polyols under optimal conditions at very low catalyst concentrations (100 ppm or less), such that removal of the catalyst from the finished product is generally no longer required. A typical example is that of the highly active DMC catalysts which are described in EP-A 700949 and contain not only a double metal cyanide compound (e.g. zinc hexacyanocobaltate(III)) and an organic complex ligand (e.g. tert-butanol) but also a polyoxyalkylene compound having a number-average molecular weight >500 g/mol. It is also possible to use the alkaline DMC catalysts disclosed in EP Application Serial No. 10163170.3.

Cyanide-free metal salts suitable for preparation of the double metal cyanide compound preferably have the general formula (IV)

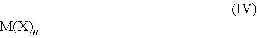

where
M is selected from the metal cations Zn²⁺, Fe²⁺, Ni²⁺, Mn²⁺, Co²⁺, Sr²⁺, Sn²⁺, Pb²⁺ and Cu²⁺; M is preferably Zn²⁺, Fe²⁺, Co²⁺ or Ni²⁺,
X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;
n is 1 when X=sulfate, carbonate or oxalate and
n is 2 when X=halide, hydroxide, cyanate, thiocyanate, isocyanate, isothiocyanate or nitrate, or suitable cyanide-free metal salts have the general formula (V)

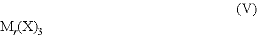

where
M is selected from the metal cations Fe³⁺, Al³⁺ and Cr³⁺,
X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;
r is 2 when X=sulfate, carbonate or oxalates and
r is 1 when X=halide, hydroxide, cyanate, thiocyanate, isocyanate, isothiocyanate, carboxylate or nitrate,
or suitable cyanide-free metal salts have the general formula (VI)

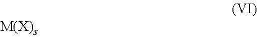

where
M is selected from the metal cations Mo⁴⁺, V⁴⁺ and W⁴⁺,
X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;
s is 2 when X=sulfate, carbonate or oxalate and
s is 4 when X=halide, hydroxide, cyanate, thiocyanate, isocyanate, isothiocyanate, carboxylate or nitrate,
or suitable cyanide-free metal salts have the general formula (VII)

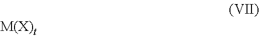

where
M is selected from the metal cations Mo⁶⁺ and W⁶⁺,
X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;
t is 3 when X=sulfate, carbonate or oxalate and
t is 6 when X=halide, hydroxide, cyanate, thiocyanate, isocyanate, isothiocyanate, carboxylate or nitrate.

Examples of suitable cyanide-free metal salts are zinc chloride, zinc bromide, zinc iodide, zinc acetate, zinc acetylacetonate, zinc benzoate, zinc nitrate, iron(II) sulfate, iron(II) bromide, iron(II) chloride, cobalt(II) chloride, cobalt(II) thiocyanate, nickel(II) chloride and nickel(II) nitrate. It is also possible to use mixtures of different metal salts.

Metal cyanide salts suitable for preparing the double metal cyanide compounds preferably have the general formula (VIII)

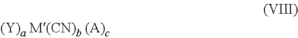

where
M′ is selected from one or more metal cations from the group consisting of Fe(II), Fe(III), Co(II), Co(III), Cr(II), Cr(III), Mn(II), Mn(III), Ir(III), Ni(II), Rh(III), Ru(II), V(IV) and V(V); M′ is preferably one or more metal cations from the group consisting of Co(II), Co(III), Fe(II), Fe(III), Cr(III), Ir(III) and Ni(II),
Y is selected from one or more metal cations from the group consisting of alkali metal (i.e. Li⁺, Na⁺, K⁺, Rb⁺, Cs⁺) and alkaline earth metal (i.e. Be²⁺, Ca²⁺, Mg²⁺, Sr²⁺, Ba²⁺),
A is selected from one or more anions from the group consisting of halides (i.e. fluoride, chloride, bromide, iodide), hydroxide, sulfate, carbonate, cyanate, thiocyanate, isocyanate, isothiocyanate, carboxylate, oxalate or nitrate and
a, b and c are integers, wherein the values for a, b and c are chosen so as to give an electrically uncharged metal cyanide salt; a is preferably 1, 2, 3 or 4; b is preferably 4, 5 or 6; c preferably has the value 0.

Examples of suitable metal cyanide salts are potassium hexacyanocobaltate(III), potassium hexacyanoferrate(II), potassium hexacyanoferrate(III), calcium hexacyanocobaltate(III) and lithium hexacyanocobaltate(III).

Preferred double metal cyanide compounds present in the inventive DMC catalysts (H) are compounds of the general formula (VIII)

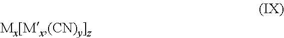

in which M is defined as in formula (IV) to (VII) and
M′ is as defined in formula (VIII) and
x, x′, y and z are integers and are selected so as to give an electrically uncharged double metal cyanide compound.

Preferably,
x=3, x′=1, y=6 and z=2,
M=Zn(II), Fe(II), Co(II) or Ni(II) and
M′=Co(III), Fe(III), Cr(III) or Ir(III).

Examples of suitable double metal cyanide compounds are zinc hexacyanocobaltate(III), zinc hexacyanoiridate(III), zinc hexacyanoferrate(III) and cobalt(II) hexacyanocobaltate(III). Further examples of suitable double metal cyanide compounds can be found, for example, in U.S. Pat. No. 5,158,922 (column 8, lines 29-66). Particular preference is given to using zinc hexacyanocobaltate(III).

The organic complex ligands added in the preparation of the DMC catalysts (H) are disclosed, for example, in U.S. Pat. No. 5,158,922 (see especially column 6 lines 9 to 65), U.S. Pat. Nos. 3,404,109, 3,829,505, U.S. Pat. No. 3,941,849, EP-A 700949, EP-A 761708, JP-A 4145123, U.S. Pat. No. 5,470,813, EP-A 743 093 and WO-A 97/40086. The organic complex ligands used are, for example, water-soluble organic compounds containing heteroatoms such as oxygen, nitrogen, phosphorus or sulfur, which can form complexes with the double metal cyanide compound. Preferred organic complex ligands are alcohols, aldehydes, ketones, ethers, esters, amides, ureas, nitriles, sulfides and mixtures thereof. Particularly preferred organic complex ligands are aliphatic ethers (such as dimethoxyethane), water-soluble aliphatic alcohols (such as ethanol, isopropanol, n-butanol, isobutanol, sec-butanol, tert-butanol, 2-methyl-3-buten-2-ol and 2-methyl-3-butyn-2-ol), compounds containing both aliphatic or cycloaliphatic ether groups and aliphatic hydroxyl groups (for example ethylene glycol mono-tert-butyl ether, diethylene glycol mono-tert-butyl ether, tripropylene glycol monomethyl ether and 3-methyl-3-oxetanemethanol). The most preferred organic complex ligands are selected from one or more compounds from the group consisting of dimethoxyethane, tert-butanol, 2-methyl-3-buten-2-ol, 2-methyl-3-butyn-2-ol, ethylene glycol mono-tert-butyl ether and 3-methyl-3-oxetanemethanol. Optionally used in the preparation of the inventive DMC catalysts (H) are one or more complex-forming component(s) from the compound classes of the polyoxyalkylene compounds, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkyl acrylates, polyalkyl methacrylates, polyvinyl methyl ethers, polyvinyl ethyl ethers, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid and maleic anhydride copolymers, hydroxyethyl cellulose and polyacetals, or of the glycidyl ethers, glycosides, carboxylic esters of polyhydric alcohols, gallic acids or salts, esters or amides thereof, cyclodextrins, phosphorus compounds, α,β-unsaturated carboxylic esters or ionic surface- or interface-active compounds.

Preferably, in the preparation of the inventive DMC catalysts (H), in the first step, the aqueous solutions of the metal salt (e.g. zinc chloride), used in a stoichiometric excess (at least 50 mol %) based on metal cyanide salt (i.e. at least a molar ratio of cyanide-free metal salt to metal cyanide salt of 2.25:1.00), and of the metal cyanide salt (e.g. potassium hexacyanocobaltate) are reacted in the presence of the organic complex ligand (e.g. tert-butanol) to form a suspension containing the double metal cyanide compound (e.g. zinc hexacyanocobaltate), water, excess cyanide-free metal salt, and the organic complex ligands. This organic complex ligand may be present in the aqueous solution of the cyanide-free metal salt and/or of the metal cyanide salt, or it is added directly to the suspension obtained after precipitation of the double metal cyanide compound. It has proven advantageous to mix the aqueous solutions of the cyanide-free metal salt and of the metal cyanide salt and the organic complex ligands with vigorous stirring. Optionally, the suspension formed in the first step is subsequently treated with a further complex-forming component. This complex-forming component is preferably used in a mixture with water and organic complex ligand. A preferred process for performing the first step (i.e. the preparation of the suspension) is effected using a mixing nozzle, more preferably using a jet disperser as described in WO-A 01/39883.

In the second step, the solids (i.e. the precursor of the catalyst of the invention) are isolated from the suspension by known techniques, such as centrifugation or filtration.

In a preferred variant for preparing the DMC catalyst (H), the isolated solids are subsequently washed in a third process step with an aqueous solution of the organic complex ligand (for example by resuspension and subsequent reisolation by filtration or centrifugation). In this way, it is possible to remove, for example, water-soluble by-products such as potassium chloride from the catalyst of the invention. It is preferable when the amount of the organic complex ligand in the aqueous wash solution is between 40% and 80% by mass, based on the overall solution.

The third step may optionally comprise admixing the aqueous wash solution with one or more further complex-forming component(s), preferably in the range between 0.5% and 5% by mass, based on the overall solution.

It is moreover advantageous to wash the isolated solid more than once. To this end, the first washing procedure may be repeated for example. However, it is preferable to use non-aqueous solutions for further washing operations, for example a mixture of organic complex ligand and further complex-forming component.

The isolated and optionally washed solid is subsequently dried at temperatures of generally 20-100° C. and at absolute pressures of generally 0.1 mbar to atmospheric pressure (1013 mbar), optionally after pulverizing.

A preferred process for isolating the inventive DMC catalysts (H) from the suspension by filtration, filtercake washing and drying is described in WO-A 01/80994.

In one embodiment of the process of the invention, the alkylene oxide (I) usable for preparation of the tertiary amine (F) containing hydroxyl groups is one or more compounds and is selected from the group consisting of 1,2-epoxybutane, propylene oxide and ethylene oxide, preferably ethylene oxide and propylene oxide, and more preferably propylene oxide.

In one embodiment of the process of the invention, the reaction in step i.-a) is effected in the absence of a superacid, for example trifluoromethanesulfonic acid (CF₃SO₃H). In accordance with the general technical definition, superacids have a pKa of less than minus three point zero (−3.0). In a preferred embodiment of the process of the invention, the reaction in step i.-a) is effected in the absence of trifluoromethanesulfonic acid.

In one embodiment of the process of the invention, step i.-a) is conducted at a reaction temperature of less than 80° C., preferably of 30° C. to 70° C. and more preferably of 35° C. to 65° C. If step i.-a) is performed at temperatures of 80° C. or higher, side reactions that lead to an elevated content of volatile by-products in intermediate (E) are observed. The reaction temperature can of course be varied within the limits described during the alkylene oxide metering phase in step i.-a).

In one embodiment of the process of the invention, in step i.-a) the total amount of component (D) containing the Brønsted acid is premixed with the H-functional starter compound (B) in the reactor before the alkylene oxide (C) is added.

In a further embodiment of the process of the invention, in step i.-a), a first portion of the component (D) containing the Brønsted acid is premixed with the H-functional starter compound (B) in the reactor before the alkylene oxide (C) is added, and at least a second subset, but preferably the full amount of component (D) containing the Brønsted acid that is still lacking is added separately to the first reactor at the same time as the addition of the alkylene oxide (C).

In variants of this embodiment of the process of the invention, in step i.-a), the additions of the alkylene oxide (C) and component (D) containing the Brønsted acid either end simultaneously or the addition of the alkylene oxide (C) ends before or after completion of addition of component (D) containing the Brønsted acid.

The H-functional starter compound (B) presented in the reactor together with (a portion of) the Brønsted acid, preferably the oxygen acid of phosphorus, is reacted in step i.-a), under inert gas atmosphere at temperatures of less than 80° C., preferably from 30° C. to 70° C. and more preferably from 35° C. to 65° C., with one or more alkylene oxides (C), where the alkylene oxide (C) but also the alkylene oxide (G) in step ii.) are fed continuously to the reactor in the standard manner in such a way that the safety-related pressure limits in the reactor system used are not exceeded. Especially in the case of metered addition of ethylene oxide-containing alkylene oxide mixtures or pure ethylene oxide, it should be ensured that a sufficient partial inert gas pressure is maintained within the reactor during the startup and metering phase. This can be established, for example, by means of noble gases or nitrogen.

The alkylene oxides (C) or (G) in step i.-a) or step ii) can be fed to the reactor in different ways: One option is metered addition into the gas phase or directly into the liquid phase, for example via an immersed tube or a distributor ring close to the reactor base in a zone with good mixing. In the case of metered addition into the liquid phase, the metered addition units should be designed so as to be self-emptying, for example by situating the metered addition holes on the underside of the distributor ring. Advantageously, it is possible by means of apparatus measures, for example the mounting of non-return valves, to prevent backflow of reaction medium into the alkylene oxide-conducting lines and metering units or into the alkylene oxide reservoir vessel. If an alkylene oxide mixture is metered in in step i.-a) and/or step ii), the respective alkylene oxides (C) and (G) can be fed to the reactor separately or as a mixture. Premixing of the alkylene oxides (C) or (G) can be achieved, for example, by means of a mixing unit present in the common metering zone (“inline blending”). It has also been found to be useful to meter alkylene oxides (C) or (G), on the pump pressure side, individually or in premixed form into a pumped circulation system conducted, for example, through heat exchangers.

In that case, for good mixing with the reaction medium, it is advantageous to integrate a high-shear mixing unit into the alkylene oxide/reaction medium stream.

If a partial flow of the Brønsted acid, preferably the oxygen acid of phosphorus, is to be fed to the reactor in parallel to the alkylene oxide stream of the alkylene oxide (C), it is advisable not to bring the partial flow of the Brønsted acid, preferably the oxygen acid of phosphorus, into contact with the alkylene oxide stream of the alkylene oxide (C) outside the actual reaction zone, in order to avoid uncontrolled and premature reaction of the alkylene oxide (C).

The temperature of the exothermic polymerization (alkylene oxide addition reaction) in steps i.-a) and ii) is maintained at the desired level or adjusted to the desired level by cooling. According to the prior art relating to the design of polymerization reactors for exothermic reactions (for example Ullmann's Encyclopedia of Industrial Chemistry, vol. B4, pp. 167 ff., 5th ed., 1992), such cooling is generally effected via the reactor wall (e.g. jacket, half-coil pipe) and by means of further heat exchange surfaces disposed internally in the reactor and/or externally in the pumped circulation system, for example in cooling coils, cooling cartridges, or plate, shell-and-tube or mixer heat exchangers. These heat exchange surfaces should be designed such that effective cooling is possible even on commencement of the metering phase, i.e. with a low fill level and/or with possibly high viscosity of the reacting reactor contents.

Generally, good mixing of the reactor contents should be ensured in all reaction phases through design and use of standard stirring units, suitable stirring units here being especially stirrers arranged over one or more levels or stirrer types which act over the full fill height (see, for example, Handbuch Apparate [Apparatus Handbook]; Vulkan-Verlag Essen, 1st ed. (1990), p. 188-208). Of particular technical relevance here is a mixing energy which is introduced on average over the entire reactor contents and is generally in the range from 0.2 to 5 W/l, with correspondingly higher local power inputs in the region of the stirrer units themselves and possibly in the case of relatively low fill levels.

In order to achieve optimal stirring action, combinations of baffles (for example flat or tubular baffles) and cooling coils (or cooling cartridges) may be arranged within the reactor according to the general prior art, and these may also extend over the vessel base. The stirring power of the mixing unit may also be varied as a function of the fill level during the metering phase, in order to ensure a particularly high energy input in critical reaction phases. For example, it may be advantageous to particularly vigorously mix solids-containing dispersions which may be present at the start of the reaction, for example, in the case of use of sucrose. Moreover, particularly when solid H-functional starter compounds are used, it should be ensured through the selection of the stirrer unit that sufficient dispersion of the solids in the reaction mixture is assured. It is preferable here to employ stirrer stages with close base clearance and particularly stirrer units suitable for suspension. In addition, the stirrer geometry should contribute to reducing foaming of reaction products. Foaming of reaction mixtures can be observed, for example, after the end of the metered addition and post-reaction phase when residual alkylene oxides are additionally removed under vacuum at absolute pressures in the range from 1 to 500 mbar. For such cases, suitable stirrer units have been found to be those which achieve continuous mixing of the liquid surface. As required, the stirrer shaft has a base bearing and optionally further support bearings within the vessel. The stirrer shaft can be driven from the top or bottom (with a central or eccentric arrangement of the shaft).

Alternatively, it is also possible to achieve the necessary mixing exclusively via a heat exchanger conducted pumped circulation system, or to operate this pumped circulation system as a further mixing component in addition to the stirrer unit, in which case the reactor contents are pumped in circulation as required (typically 1 to 50 times per hour). The specific mixing output introduced by means of pumped circulation, for example by means of an external heat exchanger or, in the case of recycling into the reactor, by means of a nozzle or injector, likewise amounts to values averaging from 0.2 to 5 W/l, this being based on the liquid volume present in the reactor and the pumped circulation system at the end of the reaction phase.

A wide variety of different reactor types are suitable for the performance of the process of the invention. Preference is given to using cylindrical vessels having a height/diameter ratio of 1:1 to 10:1. Useful reactor bases include hemispherical, dished, flat or conical bases, for example.

The end of the alkylene oxide metering phase or a change in the composition of the metered alkylene oxide mixture in step i.-a) and/or step ii) may be followed by a post-reaction phase in which residual alkylene oxide (C) and/or alkylene oxide (G) is depleted. The end of such post-reaction phases has been attained when no further pressure drop in the reaction vessel is detectable or the rate of pressure drop falls below a certain threshold value, i.e. the pressure is decreasing, for example, by less than 20 mbar/h. After the reaction phase, traces of unreacted alkylene oxides (epoxides) can be removed, if required, under reduced pressure at an absolute pressure of 1 to 500 mbar.

According to the invention, in step i.-b), the amine (F) is added to the intermediate (E) obtained in i-a to form component (A).

In this case, the amine (F) is added to the polyoxyalkylene polyol Al) obtained in step i.-a) either directly in the reaction vessel in which step i-a) was conducted or in another mixing vessel.

In a preferred embodiment of the process of the invention, step i.-b) is conducted in the first reactor in which the reaction of an H-functional starter compound (B) with an alkylene oxide (C) is also effected using a component (D).

The amount of amine to be added in step i.-b) is guided by the residual acid number ascertained in step i-a) in the intermediate product.

Preferably, the amount of the amine (F) added in step i.-b) is such that ≥0.5 to ≤2.2, preferably ≥0.8 to ≤2.0, amine nitrogen equivalents are added per residual acid equivalent in intermediate (E) in step i.-b), where the residual acid equivalent is determined with the aid of the ASTM D 7253 (2016) method.

If, for example, an ethylenediamine-started alkylene oxide addition product is used as amine (F), 1 mol of this alkylene oxide addition product can be used per residual acid equivalent. The amine (F) can be mixed with the intermediate (E) obtained from step i.-a) at room temperature or elevated temperature. Preference is also given to conducting step i.-b) under protective gas atmosphere.

Aging stabilizers or antioxidants can likewise be added if required to component (A) obtained in step i.-b), for example if this component (A) is to be stored temporarily before further conversion thereof and an insufficient amount of an antioxidant, or none, has been added after step i-a).

According to the invention, component (A) obtained in step i.) is reacted in step ii.) with the alkylene oxide (G) in the presence of the DMC catalyst (H) to give the polyoxyalkylene polyol.

Polyoxyalkylene polyols are preferably obtained here with a hydroxyl number (OH number) of >250 mg KOH/g to 600 mg KOH/g and more preferably of >300 mg KOH/g to 600 mg KOH/g. It is also additionally possible to add small amounts (1 to 500 ppm) of other organic or inorganic acids to component (A) prior to the addition of the DMC catalyst (H), as described, for example, in WO 99/14258, although this addition of acid is less preferred in the present process of the invention. The reaction of component (A) in step ii) with the alkylene oxide (C) in the presence of the DMC catalyst (H) can in principle be effected in the same reactor (first reactor) as the preparation of component (A) in step i.-a). However, it is preferable that step i.-a) and optionally step i.-b), preferably step i.-a) and step i.-b), are performed in a first reactor and step ii) in a second reactor, where the first reactor is different than the second reactor. The DMC catalyst concentration calculated based on the amount of polyoxyalkylene polyol is in the range from 20 to 1000 ppm, preferably in the range from 30 to 400 ppm, more preferably in the range from 30 to 200 ppm and most preferably in the range from 40 to 150 ppm.

The DMC-catalyzed reaction step ii) can generally be conducted according to the same processing principles as the preparation of the precursor of component A) in step i-1). Some process-related peculiarities of the DMC-catalyzed reaction step ii.) are to be addressed hereinafter.

In a preferred procedure, the reactor contents, prior to step ii.) in the presence of the DMC catalyst, are first stripped with inert gas (nitrogen or a noble gas, for example argon) at temperatures of 60 to 150° C., more preferably at temperatures of 90 to 140° C., most preferably at temperatures of 100 to 130° C., while stirring over a period of preferably 10 to 60 min. In the course of this, volatile constituents are removed with introduction of inert gases into the liquid phase with simultaneous application of reduced pressure, at an absolute pressure of 5 to 500 mbar. The temperature can subsequently be adjusted to the reaction temperature of the downstream step, for example the activation step and/or alkylene oxide addition step in step ii.), provided that it is not identical to the stripping temperature. The ultimate reaction temperature in step ii.) can alternatively be established only in the initial phase of the alkylene oxide metering, for example utilizing the liberated heat of reaction.

In a process step preceding the actual polymerization phase (alkylene oxide addition phase) by addition of the alkylene oxide (G) in step ii.), the DMC catalyst (H) can first be activated separately by adding typically 2% to 20% by mass of the alkylene oxide (G), based on the amount of component A) used in step ii). The addition of the at least one alkylene oxide (G) can take place before, during or after the heating of the reactor contents to the stripping or reaction temperature; it preferably follows the stripping. Once the metered addition of alkylene oxide (G) has been stopped after typically 2% to 20% by mass of the at least one alkylene oxide (G), based on component A) used in step ii), have been added, the activation of the DMC catalyst (H) is manifested in some cases by an accelerated drop in the reactor pressure, which indicates the commencement of alkylene oxide conversion. Then, i.e. on completion of activation, the remaining portion of the total amount of the at least one alkylene oxide (G) to be supplied for preparation of the polyoxyalkylene polyol (1) desired is supplied to the reaction mixture. In the process of the invention, however, catalyst activation is in many cases gradual, and so the stopping of the alkylene oxide dosage can be omitted and it is possible to commence directly with the continuous metered addition of the alkylene oxide (G).

The reaction temperature to be chosen in step ii) can be varied during the alkylene oxide metering phase. The reaction temperature means the average of the temperature in the reacting liquid over time during the alkylene oxide metering phase. It may be found to be advantageous to vary the reaction temperature in step ii.), for example to raise it toward the end of the alkylene oxide metering phase in order to achieve an acceleration of the alkylene oxide conversion in the last phase of the alkylene oxide metering and in the further reaction phase. Typically, the reaction temperature remains constant during the alkylene oxide metering phase in step ii). In step ii), reaction temperatures preferably in the range from 80 to 200° C., but more preferably from 100 to 160° C. and especially preferably from 135° C. to 145° C., are chosen. Observation of the reaction temperature range of 135 to 145° C. results in a comparatively small rise in pressure during the metered addition of the alkylene oxide (G) in step ii.).

In step ii.), the at least one alkylene oxide (G) can likewise be fed to the reactor in different ways in the DMC-catalyzed reaction step: One option is metered addition into the gas phase or directly into the liquid phase, for example via an immersed tube or a distributor ring close to the reactor base in a zone with good mixing. In the case of DMC-catalyzed processes, metered addition in the liquid phase is the preferred variant.

After the end of the metered addition of alkylene oxide or before a change in the alkylene oxide in step ii.), there may be post-reaction phases, or there may be intervening post-reaction phases, in which the decrease in the concentration of unreacted alkylene oxide can be quantified by monitoring the pressure. The end of such post-reaction phases has been attained when no further pressure drop in the reaction vessel is detectable or the rate of pressure drop falls below a certain threshold value, i.e. the pressure is decreasing, for example, by less than 20 mbar/h. It is optionally possible to completely free the reaction mixture, after the last further reaction phase has ended, of small amounts of unconverted alkylene oxides under reduced pressure, for example at an absolute pressure of 1 to 500 mbar, or by stripping. Stripping removes volatile constituents, for example (residual) alkylene oxides, with introduction of inert gases and/or steam into the liquid phase with simultaneous application of reduced pressure (for example by passing inert gas through at an absolute pressure of 5 to 500 mbar). The removal of volatile constituents, for example of unconverted alkylene oxides, either under reduced pressure or by stripping, is generally effected at temperatures of 20 to 200° C., preferably at 50 to 160° C., and preferably at reaction temperature with stirring. Such stripping operations can also be performed in what are called stripping columns, in which an inert gas or steam stream is passed counter to the product stream. Preference is given to using stripping columns having random packings or internals for this purpose. Such stripping operations can also be conducted continuously by, for example, collecting the unstripped material in a buffer vessel and feeding it continuously to the stripping column therefrom. On attainment of constant pressure in the further reaction phase and optionally after removing volatile constituents by means of reduced pressure and/or stripping, the product can be discharged from the reactor.

It is optionally possible to add aging stabilizers, for example antioxidants, to the mixtures containing the polyoxyalkylene polyol that have been produced by the process of the invention.

Preferably, the DMC catalyst (H) remains in the mixture containing the polyoxyalkylene polyol, preferably the mixture containing the polyether polyol, but it can also be separated off, for example by treatment with adsorbents. Processes for removing DMC catalysts are described, for example, in U.S. Pat. No. 4,987,271, DE-A 3132258, EP-A 406440, U.S. Pat. Nos. 5,391,722, 5,099,075, 4,721,818, 4,877,906 and EP-A 385619.

By the process of the invention, it is likewise possible to alter the composition of the alkylene oxide mixture not just within one of the two reaction steps but also at the changeover from the acid-catalyzed alkylene oxide addition step (steps i-a) and i-b)) to the DMC-catalyzed alkylene oxide addition step (step ii)).

If different alkylene oxides (G) are used during the DMC-catalyzed alkylene oxide addition step in step ii.), these may again be metered in either as a mixture or in succession. In the latter mode of metered addition, the polyoxyalkylene chains that continue to grow under DMC catalysis adopt block structures. It is often the case that pure ethylene oxide or mixtures of propylene oxide and ethylene oxide with a high ethylene oxide content are metered in as an end block, such that the polyoxyalkylene polyols prepared have 40% to 100% primary OH end groups. In the metered addition of two or more alkylene oxides, it is possible to change the composition of the alkylene oxide stream supplied continuously or instantaneously.

In a preferred embodiment of the process of the invention, step i.-a) and step i.-b) are performed in a first reactor and step ii) in a second reactor, where the first reactor is different than the second reactor.

It has been found that such a change of reactor leads to better activation of the DMC catalyst used in step ii.). Such improved DMC catalyst activation is manifested by a less significant rise in pressure at the same epoxide metering rate in the initial phase of step ii).

The invention further provides the intermediate (E) obtainable by the process of the invention.

The invention further provides component (A) obtainable by the process of the invention.

The invention further provides a component (A) comprising a polyoxyalkylene polyol Al) having a calculated hydroxyl number (OHN_{A1}) of 600 to 1060 mg KOH and an alkoxylated oxygen acid of phosphorus, wherein the calculated phosphorus content of 0.16% to 2.35% by weight is based on component (A). The result here is the polyoxyalkylene polyol A1) via reaction of the H-functional starter compound (B) with the alkylene oxide (C) in step i.). According to the invention, the alkoxylated oxygen acid of phosphorus means the reaction product of the inventive oxygen acid of phosphorus with the alkylene oxide (C) in step i.).

The invention further provides the mixture obtainable by the process of the invention.

In a further embodiment of the process of the invention, the molar mass of the polyoxyalkylene polyol which is obtained in step ii.) is at least 44 g/mol, preferably at least 58 g/mol and most preferably at least 88 g/mol higher than the molar mass of component A) which is obtained in step i.). In one embodiment of the invention, the polyoxyalkylene polyol present in the mixture has equivalent masses of 93 to 225 g/mol, preferably from 93 to 190 g/mol.

The invention further provides a mixture comprising a polyoxyalkylene polyol, preferably a polyether polyol having an equivalent mass of 93 to 225 g/mol, preferably of 93 to 190 g/mol, and an alkoxylated oxygen acid of phosphorus, where the calculated phosphorus content is from 0.065% to 1.287% by weight, based on the mixture. According to the invention, the alkoxylated oxygen acid of phosphorus in the present mixture means the reaction product of the inventive oxygen acid of phosphorus with the alkylene oxide (C) in step i.) and with the alkylene oxide (G) in step ii.).

The inventive mixture comprising the polyoxyalkylene polyol of the invention, preferably the mixture of the invention comprising the polyether polyol of the invention, alone or optionally in a mixture, can be reacted with organic polyisocyanates with further isocyanate-reactive components, optionally in the presence of blowing agents, in the presence of catalysts and optionally together with further additives, for example cell stabilizers, and as such serve as a component of solid or foamed polyurethanes, for example flexible polyurethane foams, especially slabstock flexible polyurethane foam and molded flexible polyurethane foam.

The invention likewise provides polyurethanes, preferably solid or foamed polyurethanes, in particular flexible polyurethane foams, for example slabstock flexible polyurethane foams and molded flexible polyurethane foams, comprising the inventive mixture comprising the inventive polyoxyalkylene polyol, preferably the inventive mixture comprising the inventive polyether polyol.

In a first embodiment, the invention encompasses a process for producing a mixture comprising a polyoxyalkylene polyol, preferably a polyether polyol, comprising the following steps:
i. providing a component A) comprising a polyoxyalkylene polyol Al) having a calculated hydroxyl number (OHN_{A1}) of 600 to 1060 mg KOH/g by
   a) reacting an H-functional starter compound (B) with an alkylene oxide (C) using a component (D), where component (D) contains a Brønsted acid, to form an intermediate (E);
   b) adding an amine (F) to the intermediate (E) obtained in i-a), to form component (A);
ii. subsequently reacting component (A) with an alkylene oxide (G) in the presence of a DMC catalyst (H) to give the mixture comprising the polyoxyalkylene polyol;
   wherein the reaction in step i.-a) is effected in the absence of a superacid, and wherein the calculated amount of Brønsted acid to be added in step i.-a) is 0.5% by weight-5.0% by weight, preferably from 1.0% by weight to 4.5% by weight and more preferably from 1.5% by weight to 4.0% by weight, based on the total mass of the intermediate (E).

In a second embodiment, the invention encompasses a process according to the first embodiment, wherein the polyoxyalkylene polyol present in the mixture has an equivalent mass of 93 to 225 g/mol, preferably of 93 to 190 g/mol.

In a third embodiment, the invention encompasses a process according to the first or second embodiment, wherein the alkylene oxide (C) is one or more compounds and is selected from the group consisting of 1,2-epoxybutane, propylene oxide and ethylene oxide, preferably propylene oxide and ethylene oxide.

In a fourth embodiment, the invention encompasses a process according to any of the first to third embodiments, wherein the Brønsted acid is an inorganic mineral acid.

In a fifth embodiment, the invention encompasses a process according to the fourth embodiment, wherein the Brønsted acid is sulfuric acid and/or an oxygen acid of phosphorus, preferably an oxygen acid of phosphorus.

In a sixth embodiment, the invention encompasses a process according to any of the first to fifth embodiments, wherein the Brønsted acid is an oxygen acid of phosphorus, preferably phosphinic acid, phosphonic acid and/or phosphoric acid (orthophosphoric acid), and more preferably phosphoric acid (orthophosphoric acid).

In a seventh embodiment, the invention encompasses a process according to any of the first to sixth embodiments, wherein the amount of the amine (F) added in step i.-b) is such that ≥0.5 to ≤2.2, preferably ≥0.8 to ≤2.0, amine nitrogen equivalents are added per residual acid equivalent in intermediate (E) in step i.-b), where the residual acid equivalent is determined with the aid of the method disclosed in the description.

In an eighth embodiment, the invention encompasses a process according to any of the first to seventh embodiments, wherein the amine (F) is a tertiary amine, preferably a tertiary amine containing hydroxyl groups.

In a ninth embodiment, the invention encompasses a process according to the eighth embodiment, wherein the tertiary amine has a hydroxyl number of 300 mg KOH/g to 1200 mg, preferably of 350 mg KOH/g to 1000 mg KOH/g, more preferably of 400 mg KOH/g to 800 mg, where the hydroxyl number has been determined by the method disclosed in the description.

In a tenth embodiment, the invention encompasses a process according to the eighth or ninth embodiment, wherein the tertiary amine is a tertiary amine containing hydroxyl groups and the tertiary amine containing hydroxyl groups is obtainable, or is preferably obtained by reaction of ammonia, a primary amine, a primary diamine, a secondary amine and/or a secondary diamine with an alkylene oxide (I) and/or by chain extension of tertiary alcoholamines with an alkylene oxide (I).

In an eleventh embodiment, the invention encompasses a process according to any of the first to tenth embodiments, wherein the alkylene oxide (G) is one or more compounds and is selected from the group consisting of 1,2-epoxybutane, propylene oxide and ethylene oxide

In a twelfth embodiment, the invention encompasses a process according to any of the first to eleventh embodiments, wherein the DMC catalyst (H) is used in amounts of 30 to 150 ppm, based on the amount of component (A) and alkylene oxide (G).

In a thirteenth embodiment, the invention encompasses a process according to any of the first to twelfth embodiments, wherein step i.-a) is conducted at a reaction temperature of less than 80° C., preferably of 30° C. to 70° C. and more preferably of 35° C. to 65° C.

In a fourteenth embodiment, the invention encompasses a process according to any of the first to thirteenth embodiments, wherein step i.-a) and optionally step i.-b), preferably step i.-a) and step i.-b), is performed in a first reactor and step ii) in a second reactor, where the first reactor is different than the second reactor.

In a fifteenth embodiment, the invention encompasses a process according to any of the first to fourteenth embodiments, wherein a first portion or the total amount of component (D) comprising the Brønsted acid is premixed with the H-functional starter compound (B), preferably in the first reactor, prior to addition of the alkylene oxide (C).

In a sixteenth embodiment, the invention encompasses a process according to any of the first to fifteenth embodiments, wherein at least a second portion of component (D) containing the Brønsted acid is added separately to the first reactor simultaneously with the addition of the alkylene oxide (C).

In a seventeenth embodiment, the invention encompasses a process according to any of the first to sixteenth embodiments, wherein the additions of the alkylene oxide (C) and component (D) comprising the Brønsted acid either end simultaneously or the addition of the alkylene oxide (C) ends before or after complete addition of component (D) comprising the Brønsted acid.

In an eighteenth embodiment, the invention encompasses a process according to any of the first to seventeenth embodiments, wherein step ii) is conducted at a reaction temperature of 135° C. to 145° C.

In a nineteenth embodiment, the invention encompasses an intermediate (E) obtainable by a process according to any of the first to eighteenth embodiments.

In a twentieth embodiment, the invention encompasses a component (A) obtainable by a process according to any of the first to eighteenth embodiments.

In a twenty-first embodiment, the invention encompasses a mixture obtainable by the process according to any of the first to eighteenth embodiments.

In a twenty-second embodiment, the invention encompasses a mixture according to the twenty-first embodiment, wherein the polyoxyalkylene polyol present in the mixture has equivalent masses of 93 to 225 g/mol, preferably from 93 to 190 g/mol.

In a twenty-third embodiment, the invention encompasses a component (A) comprising a polyoxyalkylene polyol A1) having a calculated hydroxyl number (OHN_{A1}) of 600 to 1060 mg KOH and an alkoxylated oxygen acid of phosphorus, where the calculated phosphorus content is from 0.16% to 2.35% by weight based on component (A).

In a twenty-fourth embodiment, the invention encompasses a mixture comprising a polyoxyalkylene polyol, preferably a polyether polyol having an equivalent mass of 93 to 225 g/mol, preferably of 93 to 190 g/mol, and an alkoxylated oxygen acid of phosphorus, where the calculated phosphorus content is from 0.065% to 1.287% by weight, based on the mixture.

### EXAMPLES

### General Remarks:

Pressures should fundamentally be understood as absolute pressures. Unless stated otherwise, percentages should be understood as percentages by weight.

### Methods:

### OH Number, Acid Number and Viscosity

OH numbers (OHN) were determined according to the method of DIN 53240-2 (2007), acid numbers were determined in accordance with ASTM D 7253 (2016). Viscosities were determined by a rotary viscometer (Physica MCR 51, manufacturer: Anton Paar) by the method of DIN 53018.

### Determination of Reaction Temperature T_{R}

The reaction temperature T_{R} was determined by means of a thermocouple present in the base region of the reactor used. Reaction temperature T_{R} is understood to mean the temperature of the reacting liquid.

### Raw Materials Used

### Catalyst for Alkylene Oxide Addition (DMC Catalyst):

double metal cyanide catalyst, containing zinc hexacyanocobaltate, tert-butanol and polypropylene glycol having a number-average molecular weight of 1000 g/mol; described in WO-A 01/80994, example 6.

### IRGANOX® 1076:

octadecyl 3-(3,5-di-tert-butyl-4-hydroxyphenyl) propionate. (BASF SE)

### Oxophosphoric Acid:

orthophosphoric acid, 85% w/w in water (Fisher Scientific)

### Neutralizing Agent 1 (According to the Invention):

A triethanolamine-started polyether, based exclusively on propylene oxide, with an OHN of 495 mg KOH/g, corresponding to a molar mass of 340 g/mol (Covestro)

### Neutralizing Agent 2 (According to the Invention):

An ethylenediamine-started polyether, based exclusively on propylene oxide, with an OHN of 470 mg KOH/g, corresponding to a molar mass of 477 g/mol (Covestro)

### Neutralizing Agent 3 (Comparative):

potassium carbonate (Acros)

### Preparation of Precursors in Step i-a)

### Example A, According to the Invention

A 101 laboratory autoclave under a nitrogen atmosphere was charged with 2764.2 g of trimethylolpropane (TMP) and 255.2 g of a 85% solution of orthophosphoric acid in water. During the heating phase to 100° C., oxygen was removed by 3 cycles of charging of the autoclave with nitrogen up to an absolute pressure of 4 bar, followed by evacuating to about 40 mbar while stirring (gate stirrer, 100 rpm). At 100° C., the reactor contents were stripped beneath the liquid surface while stirring at 100 rpm for a period of 3 h with introduction of 50 ml of N₂. The stirrer speed was then increased to 450 rpm and the reactor contents were cooled down to 60° C. Under these conditions, 3019 g of propylene oxide (PO) was metered into the autoclave headspace over a period of 5.1 hours.

After a further reaction time of 3.5 h, the reactor contents were heated at 60° C. under reduced pressure at a pressure of 30 mbar over a period of 30 min. After raising the pressure to atmospheric pressure, 2.412 g of IRGANOX® 1076 was added to the reactor contents.

The measured OHN of the product was 616 mg KOH/g and viscosity at 25° C. was 2315 mPas. 3.62% by weight of orthophosphoric acid was used, based on the batch composition. The theoretical phosphorus content in the precursor according to example A was 1.142% by weight.

Repeats of this batch resulted in precursors with the following indices:

### Example B, According to the Invention

Measured OHN: 623.8 mg KOH/g; acid number: 405 ppm KOH

### Example C, According to the Invention

Measured OHN: 624.9 mg KOH/g; acid number: 420 ppm KOH

### Example D, Comparative

A 10 l laboratory autoclave under a nitrogen atmosphere was charged with 2633.2 g of TMP and 386.0 g of a 85% solution of orthophosphoric acid in water. During the heating phase to 100° C., oxygen was removed by 3 cycles of charging of the autoclave with nitrogen up to an absolute pressure of 4 bar, followed by evacuating to about 40 mbar while stirring (gate stirrer, 100 rpm). At 100° C., the reactor contents were stripped beneath the liquid surface while stirring at 100 rpm for a period of 3 h with introduction of 50 ml of N₂. The stirrer speed was then increased to 450 rpm and the reactor contents were cooled down to 60° C. Under these conditions, 3039.6 g of propylene oxide was metered into the autoclave headspace over a period of 5.1 hours. After a further reaction time of 2.0 h, the reactor contents were baked at 60° C. under reduced pressure at a pressure of 35 mbar over a period of 30 min. After raising the pressure to atmospheric pressure, 2.413 g of IRGANOX® 1076 was added to the reactor contents.

The OHN of the product was 619 mg KOH/g and its acid number was 5700 ppm KOH. 5.46% by weight of orthophosphoric acid was used, based on the batch composition. The theoretical phosphorus content in the precursor according to example D was 1.727% by weight.

Production of Finished Products According to Steps i-b) and ii

The results of the tests for steps i-b) and ii are summarized in table 1.

### Example 1, According to the Invention

A 2 l laboratory autoclave under a nitrogen atmosphere was charged with 752.6 g of the precursor according to example A and 0.51 g of neutralizing agent 1. The mixture was stirred at room temperature over a period of 0.25 h (cross-beam stirrer, 200 rpm). Then 0.124 g of DMC catalyst was added and the contents of the autoclave were stripped at 130° C. at 200 rpm while stirring under reduced pressure at a pressure of about 130 mbar for 60 min with introduction of 50 ml of nitrogen per minute via a distributor ring beneath the liquid level. Then, likewise at 130° C. but with stirring at 800 rpm, 447.5 g of propylene oxide were metered into the headspace of the autoclave over a period of 4.97 h at a constant metering rate. The metered addition of propylene oxide commenced at a pressure of 0.044 bar. The maximum pressure of 3.29 bar was reached after 295 g of propylene oxide had been metered in. A further reaction time of 7.0 h was followed by devolatilization at 130° C. at an absolute pressure of 1 mbar for 0.5 h, then cooling to 80° C. and addition of 0.630 g of IRGANOX® 1076. The OH number of the product was 395 mg KOH/g and viscosity, at 25° C., was 745 mPas. The theoretical phosphorus content in the polyoxyalkylene polyol according to example 1 was 0.716% by weight.

### Example 2, Comparative

A 2 l laboratory autoclave under a nitrogen atmosphere was charged with 750.9 g of the precursor according to example B. Then 0.129 g of DMC catalyst was added and the contents of the autoclave were stripped at 130° C. at 200 rpm (cross-beam stirrer) while stirring under reduced pressure at a pressure of about 120 mbar for 45 min with introduction of 50 ml of nitrogen per minute via a distributor ring beneath the liquid level. Then, likewise at 130° C. but with stirring at 800 rpm, 450.0 g of propylene oxide were metered into the headspace of the autoclave over a period of 5.0 h at a constant metering rate. The metered addition of propylene oxide commenced at a pressure of 0.065 bar. The maximum pressure of 4.47 bar was reached after 234 g of propylene oxide had been metered in. A further reaction time of 6.0 h was followed by devolatilization at 130° C. at an absolute pressure of 1 mbar for 0.5 h, then cooling to 80° C. and addition of 0.633 g of IRGANOX® 1076. The OH number of the product was 394 mg KOH/g and viscosity, at 25° C., was 744 mPas. The theoretical phosphorus content in the polyoxyalkylene polyol according to example 2 was 0.714% by weight.

### Example 3, Inventive

A 2 l laboratory autoclave under a nitrogen atmosphere was charged with 750.0 g of the precursor according to example B and 1.900 g of neutralizing agent 1. The mixture was stirred at room temperature over a period of 0.25 h (cross-beam stirrer, 200 rpm). Then 0.123 g of DMC catalyst was added and the contents of the autoclave were stripped at 130° C. at 200 rpm while stirring under reduced pressure at a pressure of about 125 mbar for 60 min with introduction of 50 ml of nitrogen per minute via a distributor ring beneath the liquid level. Toward the end of the stripping time, the temperature was increased to 140° C. Then, likewise at 140° C. but with stirring at 800 rpm, 447.5 g of propylene oxide were metered into the headspace of the autoclave over a period of 5.03 h at a constant metering rate. The metered addition of propylene oxide commenced at a pressure of 0.062 bar. The maximum pressure of 2.85 bar was reached after 245 g of propylene oxide had been metered in. A further reaction time of 5.0 h was followed by devolatilization at 130° C. at an absolute pressure of 1 mbar for 0.5 h, then cooling to 80° C. and addition of 0.602 g of IRGANOX® 1076. The OH number of the product was 397 mg KOH/g and viscosity, at 25° C., was 766 mPas. The theoretical phosphorus content in the polyoxyalkylene polyol according to example 3 was 0.714% by weight.

### Example 4, Comparative

A 2 l laboratory autoclave under a nitrogen atmosphere was charged with 752.6 g of the precursor according to example D and 26.03 g of neutralizing agent 1. The mixture was stirred at room temperature over a period of 0.25 h (cross-beam stirrer, 200 rpm). Then 0.120 g of DMC catalyst was added and the contents of the autoclave were stripped at 130° C. at 200 rpm while stirring under reduced pressure at a pressure of about 140 mbar for 30 min with introduction of 50 ml of nitrogen per minute via a distributor ring beneath the liquid level. Thereafter, at 130° C., but with stirring at 800 rpm, a total of 447.5 g of propylene oxide was metered into the headspace of the autoclave. The metered addition of propylene oxide commenced at a pressure of 0.044 bar. The pure metering time was 5.08 h. Since a pressure of 5.5 bar had been attained after 349.5 g of propylene oxide had been metered in, the metered addition of propylene oxide had to be stopped for a period of 90 min. before the residual amount of propylene oxide could be metered in. A further reaction time of 17.5 h was followed by devolatilization at 130° C. at an absolute pressure of 1 mbar for 0.5 h, then cooling to 80° C. and addition of 0.626 g of IRGANOX® 1076. The OH number of the product was 405 mg KOH/g and viscosity, at 25° C., was 779 mPas. The theoretical phosphorus content in the polyoxyalkylene polyol according to example 4 was 1.060% by weight.

### Example 5, According to the Invention

A 2 l laboratory autoclave under a nitrogen atmosphere was charged with 750.2 g of the precursor according to example C and 1.363 g of neutralizing agent 2. The mixture was stirred at room temperature over a period of 0.25 h (cross-beam stirrer, 200 rpm). Then 0.136 g of DMC catalyst was added and the contents of the autoclave were stripped at 130° C. at 200 rpm while stirring under reduced pressure at a pressure of about 140 mbar for 60 min with introduction of 50 ml of nitrogen per minute via a distributor ring beneath the liquid level. Then, likewise at 130° C. but with stirring at 800 rpm, 451.8 g of propylene oxide were metered into the headspace of the autoclave over a period of 5.03 h at a constant metering rate. The metered addition of propylene oxide commenced at a pressure of 0.050 bar. The maximum pressure of 2.72 bar was reached after 185 g of propylene oxide had been metered in. A further reaction time of 4.0 h was followed by devolatilization at 130° C. at an absolute pressure of 1 mbar for 0.5 h, then cooling to 80° C. and addition of 0.622 g of IRGANOX® 1076. The OH number of the product was 394 mg KOH/g and viscosity, at 25° C., was 751 mPas. The theoretical phosphorus content in the polyoxyalkylene polyol according to example 5 was 0.712% by weight.

### Example 6, According to the Invention

A 2 l laboratory autoclave under a nitrogen atmosphere was charged with 749.1 g of the precursor according to example C and 2.707 g of neutralizing agent 2. The mixture was stirred at room temperature over a period of 0.25 h (cross-beam stirrer, 200 rpm). Then 0.131 g of DMC catalyst was added and the contents of the autoclave were stripped at 130° C. at 200 rpm while stirring under reduced pressure at a pressure of about 140 mbar for 60 min with introduction of 50 ml of nitrogen per minute via a distributor ring beneath the liquid level. Then, likewise at 130° C. but with stirring at 800 rpm, 451.1 g of propylene oxide were metered into the headspace of the autoclave over a period of 5.03 h at a constant metering rate. The metered addition of propylene oxide commenced at a pressure of 0.048 bar. The maximum pressure of 2.60 bar was reached after 191 g of propylene oxide had been metered in. A further reaction time of 4.0 h was followed by devolatilization at 130° C. at an absolute pressure of 1 mbar for 0.5 h, then cooling to 80° C. and addition of 0.619 g of IRGANOX® 1076. The OH number of the product was 393 mg KOH/g and viscosity, at 25° C., was 760 mPas. The theoretical phosphorus content in the polyoxyalkylene polyol according to example 6 was 0.711% by weight.

### Example 7, According to the Invention

A 2 l laboratory autoclave under a nitrogen atmosphere was charged with 748.9 g of the precursor according to example C and 1.881 g of neutralizing agent 1. The mixture was stirred at room temperature over a period of 0.25 h (cross-beam stirrer, 200 rpm). Then 0.063 g of DMC catalyst was added and the contents of the autoclave were stripped at 130° C. at 200 rpm while stirring under reduced pressure at a pressure of about 130 mbar for 60 min with introduction of 50 ml of nitrogen per minute via a distributor ring beneath the liquid level. Then, likewise at 130° C. but with stirring at 800 rpm, 451.1 g of propylene oxide were metered into the headspace of the autoclave over a period of 5.02 h at a constant metering rate. The metered addition of propylene oxide commenced at a pressure of 0.046 bar. The maximum pressure of 4.3 bar was attained after 365 g of propylene oxide had been metered in*. A further reaction time of 8.0 h was followed by devolatilization at 130° C. at an absolute pressure of 1 mbar for 0.5 h, then cooling to 80° C. and addition of 0.611 g of IRGANOX® 1076. The OH number of the product was 396 mg KOH/g and viscosity, at 25° C., was 719 mPas. The theoretical phosphorus content in the polyoxyalkylene polyol according to example 7 was 0.712% by weight.

*The halving of the amount of catalyst by comparison with example 1 explains the higher pressure level.

### Example 8, Comparative

A 2 l laboratory autoclave under a nitrogen atmosphere was charged with 752.6 g of the precursor according to example A and 0.106 g of neutralizing agent 3. The mixture was stirred at room temperature over a period of 0.25 h (cross-beam stirrer, 200 rpm). Then 0.121 g of DMC catalyst was added and the contents of the autoclave were stripped at 130° C. at 200 rpm while stirring under reduced pressure at a pressure of about 140 mbar for 60 min with introduction of 50 ml of nitrogen per minute via a distributor ring beneath the liquid level. Then, likewise at 130° C. but with stirring at 800 rpm, 447.5 g of propylene oxide were metered into the headspace of the autoclave over a period of 4.97 h at a constant metering rate. The metered addition of propylene oxide commenced at a pressure of 0.045 bar. The maximum pressure of 4.01 bar was reached after 321 g of propylene oxide had been metered in. A further reaction time of 13.5 h was followed by devolatilization at 130° C. at an absolute pressure of 1 mbar for 0.5 h, then cooling to 80° C. and addition of 0.622 g of IRGANOX® 1076. The OH number of the product was 396 mg KOH/g and viscosity, at 25° C., was 728 mPas. The theoretical phosphorus content in the polyoxyalkylene polyol according to example 8 was 0.716% by weight.

TABLE 1

| | | | | DMC catalyst | | |
|---|---|---|---|---|---|---|
| | | | Oxophosphoric | concentration | Pₘₐₓ in | OHN after |
| | Precursor | Neutralizing | acid, used in | based on mass of | step ii | step ii [mg |
| Example | [example] | agent | precursor [%] | end product [ppm] | [bar] | KOH/g] |
| 1 | A | 1 | 3.62 | 103 | 3.29 | 395 |
| 2 (comp.) | B | — | 3.62 | 107 | 4.47 | 394 |
| 3* | B | 1 | 3.62 | 103 | 2.85 | 397 |
| 4** (comp.) | D | 1 | 5.46 | 98 | 5.5 | 405 |
| 5 | C | 2 | 3.62 | 113 | 2.72 | 394 |
| 6*** | C | 2 | 3.62 | 109 | 2.60 | 393 |
| 7 | C | 1 | 3.62 | 52 | 4.3 | 396 |
| 8 (comp.) | A | 3 | 3.62 | 101 | 4.0 | 396 |

*Reaction temperature in step ii) = 140° C.
**The metered addition of epoxide was interrupted at 5.5 bar
***The amount of neutralizing agent 2 has been doubled compared to Example 5

It is apparent that the absence of neutralization of the residual acid content in the reaction product obtained after step i-a) leads to worse progression of the reaction (higher pressure level during metered addition of epoxide); the same applies to the cases shown in which a precursor with a noninventive high content of phosphoric acid was used or a neutralizing agent according to WO 2012134849 was used.

1. A process for producing a mixture comprising a polyoxyalkylene polyol, comprising:
i. providing a component A) comprising a polyoxyalkylene polyol A1) having a calculated hydroxyl number (OHN_{A1}) of 600 to 1060 mg KOH/g by
a) reacting an H-functional starter compound (B) with an alkylene oxide (C) using a component (D), where component (D) contains a Brønsted acid, to form an intermediate (E);
b) adding an amine (F) to the intermediate (E) obtained in i-a), to form component (A);
ii. subsequently reacting component (A) with an alkylene oxide (G) in the presence of a DMC catalyst (H) to give the mixture comprising the polyoxyalkylene polyol;
wherein the reaction in step i.-a) is effected in the absence of a superacid, and
wherein the calculated amount of Brønsted acid added in step i.-a) is 0.5% by weight-5.0% by weight, based on the total mass of the intermediate (E).

2. The process as claimed in claim 1, wherein the polyoxyalkylene polyol present in the mixture has an equivalent mass of 93 to 225 g/mol.

3. The process as claimed in claim 1, wherein the Brønsted acid is an oxygen acid of phosphorus.

4. The process as claimed in claim 1, wherein the amount of the amine (F) added in step i.-b) is such that ≥0.5 to ≤2.2 amine nitrogen equivalents are added per residual acid equivalent in intermediate (E) in step i.-b).

5. The process as claimed in claim 1, wherein the amine (F) is a tertiary amine.

6. The process as claimed in claim 6, wherein the tertiary amine has a hydroxyl number of 300 mg KOH/g to 1200 mg.

7. The process as claimed in claim 5, wherein the tertiary amine is a tertiary amine containing hydroxyl groups obtained by reaction of ammonia, a primary amine, a primary diamine, a secondary amine and/or a secondary diamine with an alkylene oxide (I) and/or by chain extension of tertiary alcoholamines with an alkylene oxide (I).

8. The process as claimed in claim 1, wherein step i.-a) is conducted at a reaction temperature of less than 80° C.

9. The process as claimed in claim 1, wherein step i.-a) and optionally step i.-b), is performed in a first reactor and step ii) in a second reactor, where the first reactor is different than the second reactor.

10. The process as claimed in claim 1, wherein step ii) is performed at a reaction temperature of 135° C. to 145° C.

11. An intermediate (E) obtained by a process as claimed in claim 1.

12. A component (A) obtained by a process as claimed in claim 1.

13. A mixture obtained by a process as claimed in claim 1.

14. A component (A) comprising a polyoxyalkylene polyol A1) having a calculated hydroxyl number (OHN_{A1}) of 600 to 1060 mg KOH and an alkoxylated oxygen acid of phosphorus, wherein the calculated phosphorus content of 0.16% to 2.35% by weight is based on component (A).

15. A mixture comprising a polyoxyalkylene polyol having an equivalent mass of 93 to 225 g/mol and an alkoxylated oxygen acid of phosphorus, where the calculated phosphorus content is from 0.065% to 1.287% by weight, based on the mixture.

16. The process as claimed in claim 1, wherein:
(i) the polyoxyalkylene polyol is a polyether polyol with an equivalent mass of 93 to 190 g/mol;
(ii) the reaction of the H-functional starter compound (B) with an alkylene oxide (C) using a component (D) takes place at a reaction temperature of 35° C. to 65° C.;
(iii) component (D) contains a phosphoric acid;
(iv) the amine (F) is a tertiary amine containing hydroxyl groups and has a hydroxyl number of 400 mg KOH/g to 800 mg KOH/g,
(v) the amine (F) is obtained by reaction of ammonia, a primary amine, a primary diamine, a secondary amine and/or a secondary diamine with an alkylene oxide (I) and/or by chain extension of a tertiary alcohol amine with an alkylene oxide (I), and
(vi) the amount of the amine (F) added in step i.-b) is such that ≥0.8 to ≤2.0 amine nitrogen equivalents are added per residual acid equivalent in intermediate (E) in step i.-b);
(vii) the calculated amount of phosphoric Brønsted acid added in step i.-a) is 1.5% by weight to 4.0% by weight, based on the total mass of the intermediate (E), and
(viii) step i.-a) and step i.-b) are performed in a first reactor and step ii) in a second reactor, where the first reactor is different than the second reactor.

17. The process as claimed in claim 1, wherein the Brønsted acid is phosphoric acid.

18. The process as claimed in claim 1, wherein the amine (F) is a tertiary amine containing hydroxyl groups with a hydroxyl number of 400 mg KOH/g to 800 mg KOH/g.

19. The mixture as claimed in claim 15, wherein the polyoxyalkylene polyol is a polyether polyol having an equivalent mass of 93 to 190 g/mol, and the calculated phosphorus content is from 0.065% to 1.287% by weight, based on the mixture.
